(19) United States
(12) Patent Application Publication
(10) Pub. No.: US 2015/0057144 A1
(43) Pub. Date: Feb. 26, 2015

(54) NANOSTRUCTURED COMPOSITE MATERIALS COMPRISING REFRACTORY ELEMENTS

(71) Applicant: The Johns Hopkins University, Baltimore, MD (US)

(72) Inventors: Jonah Erlebacher, Chevy Chase, MD (US); Ian McCue, Baltimore, MD (US)

(73) Assignee: The Johns Hopkins University, Baltimore, MD (US)

(21) Appl. No.: 13/975,659

(22) Filed: Aug. 26, 2013

(51) Int. Cl. C22C 32/00; B05D 5/00; B05D 3/10; B05D 1/38; C04B 35/01; C04B 35/58

(52) U.S. Cl. CPC C22C 32/0047; C04B 35/016; C04B 35/58007; B05D 3/105; B05D 1/38; B05D 5/00; C22C 32/001; C22C 32/0094
USPC 501/96.1; 501/94; 420/427; 420/430; 420/429; 420/425; 420/433; 427/343

(57) ABSTRACT

A bicontinuous non-porous microstructure comprising a refractory phase and a non-refractory phase, wherein the refractory phase substantially comprises one or more refractory elements and the non-refractory phase comprises a void filled by one or more materials that are different than a material comprising the non-refractory phase in a bicontinuous network from which the nanocomposite refractory material is formed and methods of making the same are disclosed.

### FEDERALLY SPONSORED RESEARCH OR DEVELOPMENT

This invention was made in part with United States Government support under DMR-1003901 awarded by the U.S. National Science Foundation (NSF). The U.S. Government has certain rights in the invention.

### BACKGROUND

Refractory metal elements, which include tantalum (Ta), tungsten (W), molybdenum (Mo), niobium (Nb), and rhenium (Re), are known for their high melting points and are important components of engineering materials including, but not limited to, superalloys, electronics, materials for corrosive environments, materials for refractory applications, materials resistant to radiation damage, and capacitors. Callister, 2006; Roesler, et al., 2006.

Methods currently known in the art for processing refractory metal elements into such materials typically involve sintering compacted powders, some fraction of which contains powders of refractory metal elements. Sintering allows mechanically robust materials to be formed at temperatures significantly lower than the melting points of refractory metal elements. Sintering, however, often leads to materials having large concentrations of microstructural defects, such as grain boundaries, impurities at grain boundaries, and, as a result, limits the use of refractory elements in many applications.

### SUMMARY

In some embodiments, the presently disclosed subject matter provides a nanocomposite refractory material comprising: a bicontinuous non-porous microstructure comprising a refractory phase and a non-refractory phase, wherein the refractory phase substantially comprises one or more refractory elements and the non-refractory phase comprises a void filled by one or more materials, wherein the one or more materials filling the void are different than a material comprising the non-refractory phase in a bicontinuous network from which the nanocomposite refractory material is formed.

In other aspects, the presently disclosed subject matter provides a method for preparing a nanocomposite refractory material comprising a bicontinuous solid microstructure comprising a refractory phase and a non-refractory phase, wherein the refractory phase substantially comprises one or more refractory elements, and the non-refractory phase comprises a void filled by one or more materials, wherein the one or more materials filling the void are different than a material comprising the non-refractory phase in a bicontinuous network from which the nanocomposite refractory material is formed, the method comprising: (a) immersing a precursor alloy comprising one or more refractory elements and a first metal in a molten metal bath comprising one or more second metals to form a bicontinuous network comprising a refractory phase comprising one or more refractory elements and a non-refractory phase comprising the one or more second metals; (b) cooling the bicontinuous network to form a solidified material comprising a refractory phase and a non-refractory phase; (c) immersing the solidified material in an acid or alkali aqueous solution, wherein the one or more second metals comprising the non-refractory phase are dissolved in the acid or alkali aqueous solution, thereby forming an intermediate nanostructured refractory material having a void in the non-refractory phase; and (d) filling the void in the non-refractory phase of the intermediate nanostructure refractory material with a material different from the one or more second metals comprising the molten metal bath to form a nanostructure refractory material.

In certain aspects, the one or more different materials is selected from the group consisting of a polymer, an oxide, a ceramic, an alloy, or a metal that was not a constituent of the liquid metal bath.

In further aspects, the method comprises chemically transforming a surface, bulk, and combination thereof of the refractory phase into an oxide, a nitride, or a carbide of the refractory element thereof.

In yet further aspects, the presently disclosed subject matter provides a nanocomposite refractory material prepared by the presently disclosed methods. In some aspects, the nanocomposite refractory material comprises Ta—Ta₂O₅—MnO. In yet further aspects, the nanocomposite refractory material comprises a capacitor.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF FIGURES

Having thus described the presently disclosed subject matter in general terms, reference will now be made to the accompanying Figures, which are not necessarily drawn to scale, and wherein:

FIG. 1 is a schematic representation of the presently disclosed method for fabricating a nanocomposite refractory material including: a cross-section side view depicting a process of immersing a metal alloy into a molten metal bath, and a cross-section side view showing an enlarged view of the forming microstructure;

FIG. 2 shows a scanning electron microscope (SEM) micrograph of a nanocomposite refractory material comprising copper (dark non-refractory phase) and tantalum (light refractory phase) prepared by the presently disclosed methods;

FIG. 3a and FIG. 3b show: (a) a schematic representation of the presently disclosed method of immersing a nanocomposite refractory material, formed by the method depicted in FIG. 1, into an acid or alkali aqueous solution to form an intermediate nanostructured refractory material; and (b) a schematic of the resulting microstructure after the material has been removed from the solution and dried;

FIG. 4 shows an SEM micrograph of an intermediate nanostructured refractory material comprising tantalum formed by the method disclosed in FIG. 3a, and described herein;

FIG. 5a and FIG. 5b show: (a) a schematic of an intermediate nanostructured refractory material, formed by the method depicted in FIG. 3a; and (b) a schematic representation of the presently disclosed method of immersing an intermediate nanostructured refractory material in a liquid phase to form a new nanocomposite refractory material;

FIG. 6a and FIG. 6b show: (a) a schematic of an intermediate nanostructured refractory material, formed by the method depicted in FIG. 3a; and (b) a schematic of the intermediate refractory material after it has undergone a treatment to modify its surface;

FIG. 7 shows an SEM micrograph of an intermediate nanostructured refractory material comprising tantalum, wherein the intermediate nanostructured refractory material has a smaller characteristic length scale than the example in FIG. 4, formed by the method described in Example 2;

FIG. 8 shows a graph of Vickers hardness values for several different materials, including: the Ta—CuAg composite material from FIG. 4, a 40Ta—60Ti alloy, pure Ta, and pure Cu;

FIG. 9 shows a SEM micrograph of an intermediate nanostructured refractory material comprising tantalum, wherein the intermediate nanostructured refractory material has yet a smaller characteristic length scale than the examples in FIG. 4 and FIG. 7, formed by the method described in Example 3;

FIG. 10 shows a scanning electron microscope (SEM) micrograph of a nanocomposite refractory material comprising copper (dark non-refractory phase) and tungsten (light refractory phase) prepared by the presently disclosed methods; and

FIG. 11 shows a graph of Vickers hardness values for several different materials, including: the W—Cu composite material from FIG. 4, a 25W—75Ti alloy, pure W, and pure Cu.

### DETAILED DESCRIPTION

The presently disclosed subject matter now will be described more fully with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.
I. Nanostructured Composite Materials Comprising Refractory Elements

In some embodiments, the presently disclosed subject matter provides methods for processing refractory elements into composite materials having a controlled microstructure and superior properties, including strength and toughness, as compared to sintered materials known in the art.

For many applications, it is desirable to use materials having a high yield strength and toughness. A crystalline material's yield strength is defined as that stress (force/area) at which the material begins to plastically (permanently) deform. The yield strength of a material is orders of magnitude smaller than the theoretical value associated with the stress required to pull crystalline lattice planes apart by directly breaking the bonds between them. Callister, 2006; Roesler, et al., 2006. This characteristic arises because the mechanism by which plastic deformation typically occurs is a propagating slippage of atomic planes via a crystalline line defect known as a dislocation. Callister, 2006; Roesler, et al., 2006.

Several ways to strengthen a metal alloy are commonly known and industrially relevant. One such method is referred to as precipitation hardening. Callister, 2006; Roesler, et al., 2006. During precipitation hardening a homogeneous alloy is cooled from an elevated temperature to a temperature where the solubilities of the alloying components are different and other crystalline phases may be more thermodynamically stable. Callister, 2006; Roesler, et al., 2006. This process produces small particles of one alloy component via precipitation from the supersaturated parent alloy. Often, the precipitates have diameters ranging between about 1 nm and about 1000 nm. These precipitates enhance the yield strength of the overall material by impeding the motion of dislocations [Callister, 2006; Roesler, et al., 2006; Pollock, 2006; and Decker, 1969. It has been found that an optimum precipitate particle size lies between about 5 nm to about 30 nm Callister, 2006; Ballufi, et al., 2005. Whether or not an alloy can be precipitation hardened depends on the particular properties of the alloy under consideration.

Another method to increase the yield strength of a metal is to reduce the crystalline grain diameter, a process referred to as grain refining. Many materials follow behavior associated with the so-called Hall-Petch equation, which states that the yield strength of a material is inversely proportional with the average grain diameter, usually according to a power law relation, and more specifically according to:

σ_{Y}=σ₀+A/\sqrt{d}

where σ_{y} is the yield strength, d is the average grain size; σ₀ and A are constants whose value depends on the particular materials being considered. Callister, 2006; Roesler, et al., 2006. Refractory elements are intrinsically hard, in the sense that values for σ₀ are relatively high, but high temperature sintering typically results in dimensions for d greater than 1000 nm, thereby reducing Hall-Petch hardening. Chen, et al., 2005.

A material defined as having a high toughness can plastically deform significant amounts before failing. Callister, 2006; Roesler, et al., 2006. Equivalently, toughness is a measure of the ability of a material to absorb energy prior to failure. Callister, 2006; Roesler, et al., 2006. Often, high strength materials made either by precipitation hardening or by sintering of small grain powders suffer from low toughness, because the significant density of grain boundaries act either as crack initiation points or as geometric positions where dislocation flow required for ductility is impeded.

Wang and Weissmuller disclose a strategy for preparing a composite material that is stronger and tougher than the individual constituents of the composite. Wang and Weissmuller, 2013. This material is made by first synthesizing a sample of nanoporous gold using electrochemical dealloying. Wang and Weissmuller, 2013. Electrochemical dealloying refers to the procedure in which a two-component alloy is placed in an appropriate electrolyte such that one of the components is dissolved away under conditions where the remaining component diffuses along the metal/electrolyte interface and re-organizes itself into a three-dimensional porous metal. Erlebacher, 2004. For example, nanoporous gold can be fabricated by dealloying silver from silver/gold alloys. Erlebacher, 2004. Materials prepared in this way are characterized by a bicontinuous, open porosity.

As used herein, the term “bicontinuous” refers to a morphology comprising two interpenetrating phases, wherein each phase is interconnected. By “interpenetrating” is meant that the first phase and the second phase each form networks that are continuous in two or three dimensions and that each phase extends a distance into the other phase. By “interconnected” is meant that each phase itself is continuous. In contrast, a two-phase material containing a primary phase and a secondary phase precipitated within the primary phase is not bicontinuous because the secondary phase is not interconnected. For instance, the precipitation hardening process results in the formation of discrete particles of the secondary phase within the primary phase, and phase comprised of particles is not interconnected and the microstructure is not bicontinuous.

Bicontinuous morphologies can be characterized by the average diameter of the ligaments within each phase. In some bicontinuous microstructures, including the bicontinuous microstructures disclosed herein, the diameters of the ligaments within each phase are approximately the same. Accordingly, this characteristic of the bicontinuous morphology can be referred to by a single number called the “characteristic length scale.” For instance, nanoporous gold possesses a bicontinuous microstructure, one phase of which comprises gold, and the other phase of which is a void whose characteristic length scale can be controlled from about 5 nm to about 1000 nm by varying the relative rate of silver dissolution and gold surface diffusion.

Wang and Weissmuller, 2013; Erlebacher, 2004. For example, the faster the dissolution, the smaller the pores. Erlebacher, 2004.

Importantly, the grain size of nanoporous gold is very large compared to the characteristic length scale of the metal. Snyder, et al., 2008. That is, the porosity itself is essentially a single-crystal network extending to sizes orders of magnitude larger than the pores or ligaments themselves, i.e., the porous network contains no grain boundaries except those that existed in the parent alloy. Snyder, et al., 2008. Also importantly, when the characteristic length scale of nanoporous gold drops below 100 nm, the mechanical properties of nanoporous gold are those of brittle materials, Li and Sieradzki, 1992. Accordingly, such materials exhibit very low toughness, but the yield strength of such materials approaches that of the theoretical yield strength of gold. Li and Sieradzki, 1992.

Without wishing to be bound to any one particular theory, it is thought that these properties are due to the small characteristic length scale, in that dislocations can only propagate the length of a ligament diameter before they are annihilated at the free surface on the other side of the ligament. Under such circumstances, large-scale ductility is suppressed. Jin et al., 2009. Wang and Weissmuller, however, showed that, by impregnating the pores of nanoporous gold with a ductile polymer, a composite material is formed that has higher strength than either component of the composite material and has a higher toughness than either component. Wang and Weissmuller, 2013.

Wada and Kato disclose a method for creating porous metals by starting with a multi-component alloy and immersing the alloy into an appropriate molten metal bath at elevated temperature such that one of the alloy components is dissolved into the molten metal bath. Wada and Kato, 2013. During dissolution of this alloy component, the other element reorganizes into a bicontinuous network filled with the molten metal. A porous metal is formed by solidifying the alloy and dissolving away the phase comprising the molten metal. Wada and Kato, 2013.

The physics controlling the formation of the porous structure described by Wada and Kato are essentially the same as that in electrochemical dealloying, except Wada and Kato used a molten metal instead of an aqueous electrolyte. Wada and Kato, however, did not disclose the mechanical properties of any of the porous materials prepared by their method. Wada and Kato, 2013; see also U.S. Patent Application Publication No. 2012/0295129, to Kato et al., published Nov. 22, 2012, which is incorporated herein by reference in its entirety.

In contrast to the materials and methods disclosed in Wada and Kato, Kato et al., and Wang and Weissmuller, the presently disclosed methods create a solid, non-porous, composite material in which the microstructure is controllable such that the mechanical and functional properties of the material can be optimized. The presently disclosed materials are bicontinuous, as defined herein, and generally are referred to as “nanocomposite refractory materials” or “nanocomposite refractories,” which terms are used interchangeably. Further, the terms “nanocomposite refractory materials” or “nanocomposite refractories,” as used herein, indicate that one phase of the bicontinuous microstructure is primarily or substantially comprised of a refractory element, although the other phase may not necessarily be refractory or even a metal. As used herein, the term “substantially” refers to a phase comprising 100%, 99.9%, 99.5%, 98%, 95%, or 90% of a refractory element.

If one of the phases of the presently disclosed nanocomposite refractory materials were to be dissolved away, the remaining materials would look like nanoporous materials made either by electrochemical dealloying or the liquid phase dealloying method disclosed by Kato et al. Although in some embodiments, the presently disclosed nanocomposite refractory materials pass through an intermediate processing step in which the non-refractory phase is dissolved away, the final product materials disclosed here are not porous.

It is well-known that all of the refractory metal elements form homogeneous solid solutions with titanium (Ti) at a sufficiently high temperature. Kaufman, 2006(a); Jonsson, 2006; Rudy, 2006; Okamoto, 2006(a); and Murray, 2006. Further, all of the refractory elements are immiscible in particular molten metals, including copper, silver, bismuth, and alloys of these components. Titanium, however, readily dissolves into molten baths of these materials. Kaufman, 2006(b); Okamoto, 2006(b); Turchanin, 2006; Li, 2006; Vassilev, 2006. Other suitable molten materials may be known to those of ordinary skill in the art.

Accordingly, as disclosed herein, when an alloy of a refractory element(s) and titanium, where titanium has an atomic percent composition greater than 50% so that it is the majority component, is immersed into a bath of, for example, molten copper, it will spontaneously form a bicontinuous network comprising (a) a refractory phase comprising the refractory element(s), e.g., tantalum; and (b) a non-refractory phase comprising the molten metal, e.g., copper. This bicontinuous network can then be cooled to form a bicontinuous two-phase nanocomposite refractory material comprising: (a) a hard phase comprising the refractory metal, and (b) a relatively ductile phase comprising the solidified molten metal bath material. Depending on the temperature of the molten metal, the characteristic length scale of the nanocomposite refractory material can be controlled from about 10 nm to about 10,000 nm.

The presently disclosed nanocomposite refractories will lead to enhanced mechanical properties. For example, the refractory phase of a nanostructured composite is likely to be dislocation free, which can be expected to increase a nanocomposite refractory's yield strength for the following reason: dislocations need to be nucleated before plastic (permanent) deformation can occur, and current understanding of the mechanical properties predicts that the critical stress, σ_{c}, required to nucleate a dislocation can be expressed as σ_{c}—R⁻ⁿ, where R is the characteristic length scale, and n is a constant with a value of approximately 0.68. Mordehai, 2011. Accordingly, as the characteristic length scale of a nanocomposite refractory decreases, the critical yield stress for dislocation nucleation should near the material's theoretical yield strength.

Further, as with electrochemically dealloyed metals, the refractory phase of the nanocomposite refractory material comprising the refractory element(s) is free of grain boundaries, except as those existing in the parent alloy. For this reason, the mechanical properties of the presently disclosed nanocomposite refractory metals are superior to the mechanical properties of materials formed by grain refining because the high strength associated with the small characteristic length scale is not simultaneously linked to a high grain boundary density.

Additionally, keeping a large grain size will increase the resistance of the nanocomposite refractories to creep. As used herein, “creep” is defined as plastic deformation at elevated temperatures below the material's yield strength.

Nanocomposite refractory materials should possess high creep resistance in part due to the high melting point of the refractory elements, but also due to the nanocomposite's bicontinuous structure's inherent resistance to shear. The following equation can be used to express the stress required, σ_{R}, for a dislocation to glide through a narrow channel:

σ_{R}=\sqrt{⅔}(μb/hS)

where μ is the shear modulus, b is the Burgers vector, S is the Schmid factor, and h is the width of the channel. Pollock and Tin, 2006. Typical high temperature, e.g., 850° C. operating temperature, precipitation hardened materials have channel widths of about 60 nm, and a σ_{R} of about 408 MPa, but altering the channel width to about 10 nm would increase the required stress by a factor of six. Ding, et al., 2004. Creep-resistant materials can be used in structural applications at high temperatures.

Also, the cooling protocol can be tailored such that, upon cooling, thermal contraction will cause the refractory phase to be in compression, such that if cracks open up in this phase they will be pushed closed by expansion of the more ductile, non-refractory phase, leading to a further enhancement of the toughness of the final product. Thus, the presently disclosed composites can be both strong and tough.

It is well known that nanoporous metals made by dealloying are brittle, with little toughness. This characteristic arises because the energy associated with dislocation annihilation during plastic deformation at the free surfaces of nanoporous metals is dissipated into the void between ligaments. Jin, et al., 2009. In contrast, when the refractory phase of the presently disclosed nanocomposite refractories plastically deforms at high stress, it can be expected that dislocations will be injected into the ductile, non-refractory phase of the nanocomposite, and their energy absorbed in this phase.

Further, the thermal expansion coefficient of the ductile phase of nanocomposite refractories is typically larger than the thermal expansion coefficient of the refractory phase. Therefore, upon cooling, the ductile phase will tend to shrink more than the refractory phase. As a result, the ductile phase is expected to be in tension and the refractory phase to be in compression. Accordingly, if a crack appears in the stiff, refractory phase, it should be pulled closed by local compression of the ductile phase as it relieves its tensile stress. This effect also will increase toughness.

Further, another enhanced property is linked to the large interface areas between the refractory phase and the ductile, non-refractory phase, which are expected to serve as sinks for diffusing point defects, including, but not limited to, vacancies and interstitial defects, and dissolved gasses, such as hydrogen and helium. These defects are commonly created during exposure to radiation, and thus the presently disclosed nanocomposite refractory materials can be expected to retain their properties even after receiving significant doses of radiation.

It is well-known to practitioners of the art that metals exposed to high-energy radiation are damaged because: (i) point defects are created during radiation exposure, and these point defects can accumulate, which leads to embrittlement of the material, and (ii) certain radiations can create bubbles of helium or hydrogen in the material, which also leads to embrittlement. The presently disclosed nanocomposite refractories have large areas of internal interface between the refractory phase (with typically body-centered cubic crystal structure) and the ductile phase (with typically face-centered cubic crystal structure) that should serve as sinks for point defects; also, refractory metals have high capacities for absorbing hydrogen and helium.

The properties of each phase can be further tailored to enhance the properties of nanocomposite refractory materials. For example, dissolved titanium in the remaining ductile phase can be precipitated within that phase, inducing further hardness.

Also, the interface between the refractory phase and the ductile, non-refractory phase can be chemically modified to form stiff oxide, nitride, or carbide layers between the phases. One method for modifying this interface is to dissolve away, i.e., excavate, the ductile, non-refractory phase, then expose the excavated refractory phase to oxygen, nitrogen, or carbon, and then backfill the excavated phase by immersing the material in a bath of molten metal and cooling. Further, the ductile, non-refractory phase also can be replaced by dissolving it away and filling the remaining void phase with any other desired material, e.g., a polymer, an oxide, a ceramic, an alloy, or a metal that was not a constituent of the liquid metal bath.

As a first example, the copper phase of a nanocomposite comprising a Ta refractory and a Cu non-refractory phase can be dissolved away. Then, the tantalum surface can be oxidized and the void re-filled with, for example, manganese oxide to form a metal/oxide nanocomposite refractory that could be used as a capacitor. As a second example, the copper phase of a nanocomposite comprising a Ta refractory and a Cu non-refractory phase can be dissolved away and the void re-filled with an aluminum alloy by immersing the material in a molten aluminum alloy and cooling the composite.

The presently disclosed subject matter provides a method for fabricating refractory-based nanocomposite materials for high-strength applications, as well as electronics applications, such as capacitors. Further, the presently disclosed methods allow for the fabrication of nanocomposite refractories having characteristic length scales that can be tailored from about 10 nm to about 10,000 nm.

A first embodiment of the presently disclosed subject is now described with reference to an example in which a copper-tantalum (Cu—Ta) nanocomposite refractory is fabricated by immersing a titanium-tantalum (Ti—Ta) alloy into a molten copper bath. Referring to the ASM Alloy Phase Diagram Database it is readily apparent that Ti—Ta forms a solid solution body-centered cubic phase across all compositions.

Titanium can dissolve into molten copper at temperatures as low as about 883° C., and is soluble in molten copper up to about 80 atomic percent titanium. In contrast, tantalum and copper are immiscible up to approximately 1500° C. Jonsson, 2006; Okamoto, 2006(b); Li, 2006.

Based on the phase diagrams, it can be inferred that tantalum and copper have a positive heat of mixing, which means forming an alloy or compound is energetically unfavorable, and that both tantalum-titanium and titanium-copper have negative heat of mixings, which means that forming an alloy or compound is energetically favorable.

It should be noted that the class of refractory metals all have similar melting points and physical characteristics. As such, the previously described system can be generally described as a X—Ti alloy in molten Cu, where X can be W, Ta, Mo, Nb, Re, or any combination of these five refractory elements forming an alloy where the Ti content is at least 50 atomic percent of the alloy.

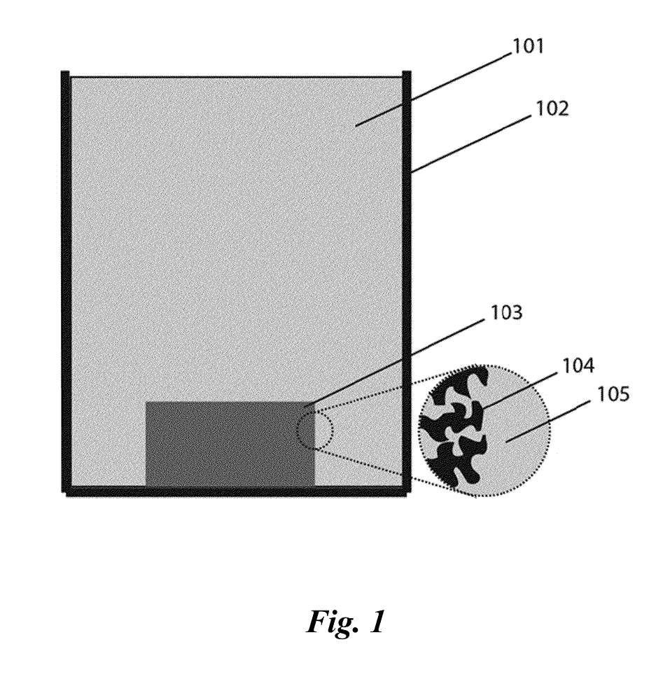

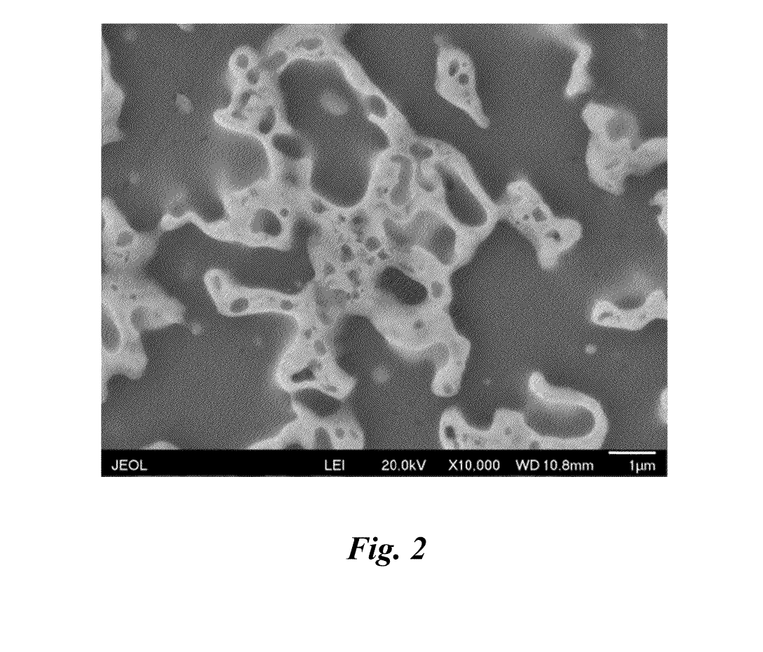

Referring now to FIG. 1, a metal bath 101 of copper is prepared in a crucible 102 and a metal alloy 103 (Ti—X) comprising titanium (Ti) and a refractory element X is placed therein. The molten metal bath 101 is maintained at a temperature at which dissolving titanium from the metal alloy 103 will not increase the melting point of the bath 103 as it enriches in titanium. As the titanium component from the metal alloy 103 dissolves into the metal bath 101, the tantalum will reorganize itself such that the tantalum and the molten metal form a bicontinuous microstructure 104 comprising a solid phase substantially comprising a refractory element X and a liquid molten metal bath 101 phase. The molten metal bath 101 and metal alloy 103 are then cooled to room temperature in the crucible, and, as a result, the constituents of the molten metal bath 101 are trapped inside the nanostructure 104 and form a bicontinuous nanocomposite refractory. The nanocomposite refractory prepared following this method can be seen in FIG. 2. The light regions are the refractory element, e.g., tantalum, the dark regions are the molten metal, e.g., copper, and the characteristic length scale is of the order of about one micrometer.

The composite formed by the presently disclosed methods does not need to be limited to a two-phase structure consisting of a refractory metal and the constituents of the molten metal bath. In some embodiments, a different material is included in the non-refractory phase of the nanocomposite refractory, such as a polymer, an oxide, a ceramic, an alloy, or a metal that was not a constituent of the liquid metal bath. In other embodiments, the refractory material can be modified by oxidizing, nitriding, or carburizing its surface to form a ceramic material. In further embodiments, the refractory phase can be modified by completely oxiding, nitriding, or carburizing it to transform it into a refractory ceramic phase. To accomplish any of these embodiments, an intermediate nanostructured refractory material is initially formed.

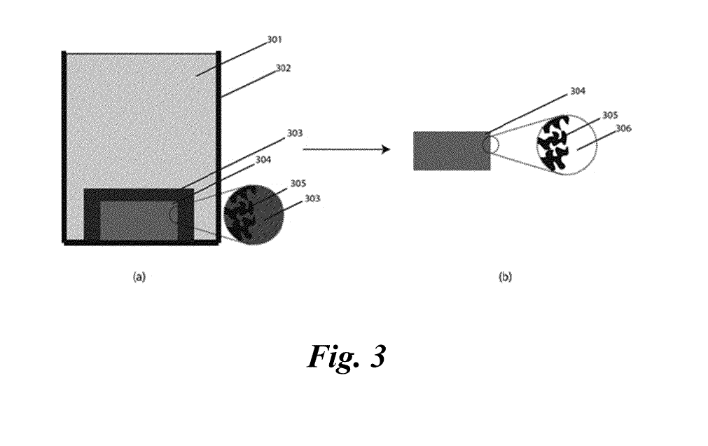

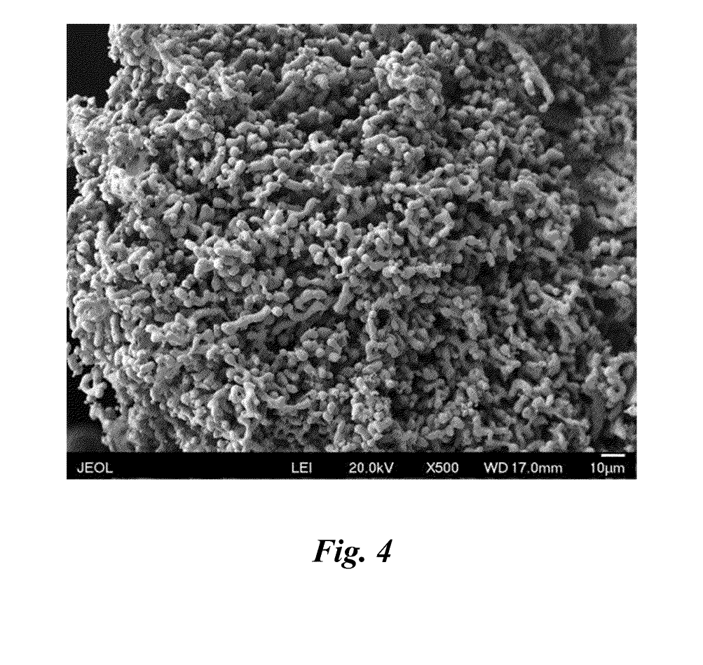

Referring now to FIG. 3, an aqueous solution 301 that is either acidic or alkali is prepared in a container 302 and the solidified material containing the molten metal bath constituents 303 and the nanocomposite refractory material 304, comprising the refractory element, e.g., tantalum, structure 305 and constituents of molten metal bath 303, is placed inside. The solution is chosen such that one of the components, in this example, the constituents of metal bath 303, is dissolved away into the solution. The resulting structure is a nanocomposite refractory material 304 comprised solely of an intermediate nanostructured refractory material 305 and having a void phase 306. See, for example, FIG. 4.

In such embodiments, nanocomposite refractories can be fabricated from intermediate nanostructured refractory materials. It has been shown in previous work that nanostructures, such as nanoporous gold (NPG), can be filled with a secondary phase. Wang and Weissmuller, 2013. The resulting structure was both strong and possessed significant ductility, combining the properties of the two components. Wang and Weissmuller, 2013. Interestingly, the composite exhibited much higher yield strength than either of the pure constituents, which has been attributed to the bicontinuous microstructure and the resulting interfacial phenomena. Wang and Weissmuller, 2013.

Adding a polymer to NPG imparts ductility to the material and is compatible with low temperature processing. NPG is known to coarsen at low temperatures, and thus backfilling the nanostructure with a molten metal is not feasible. Ding, et al., 2004. The intermediate nanostructured refractory materials disclosed herein may not coarsen or otherwise change shape at temperatures less than about 2000° C. due to the refractory elements' high melting points and BCC crystal structure, and thus can be filled with a multitude of molten materials. The molten material could be a polymer, an oxide, a ceramic, an alloy, or a metal that was not a constituent of the liquid metal bath.

In other embodiments, intermediate nanostructured refractory materials can be filled with oxides via chemical decomposition of salts precipitated within the void phase.

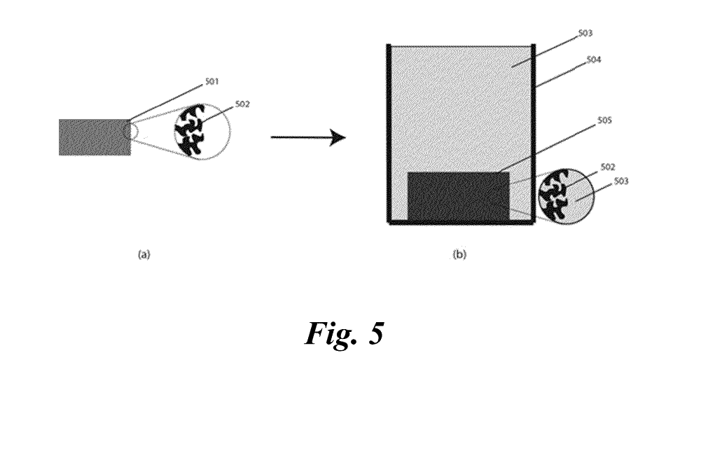

Referring now to FIG. 5, a nanostructured refractory material 501 comprised solely of an intermediate nanostructured refractory material 502 is immersed in a liquid phase 503 comprising one or more constituents inside a container 504, and a new nanocomposite refractory material 504 is formed comprised of intermediate nanostructured refractory material 502 and the one or more constituents of the liquid phase 503. The liquid phase 503 is not limited to a liquid metal, softened polymer, or water with dissolved constituents.

In other embodiments, the surface or bulk of an intermediate nanostructured refractory material can be modified to alter its mechanical and/or electrical properties. This modification can be done by oxidation, carburization, or nitridation before a new second phase is added to form the nanocomposite refractory. Many different techniques to oxidize, carburize, or nitride materials are known to one of ordinary skill in the art. Chen, 1996. Carbide and nitride materials have a unique combination of properties, namely: high strength and hardness; high melting temperatures; and excellent electrical and thermal conductivity. Mordehai, et al., 2011. After formation, the void phase of the modified intermediate nanostructured refractory material can be filled with a second phase to complete the nanocomposite refractory.

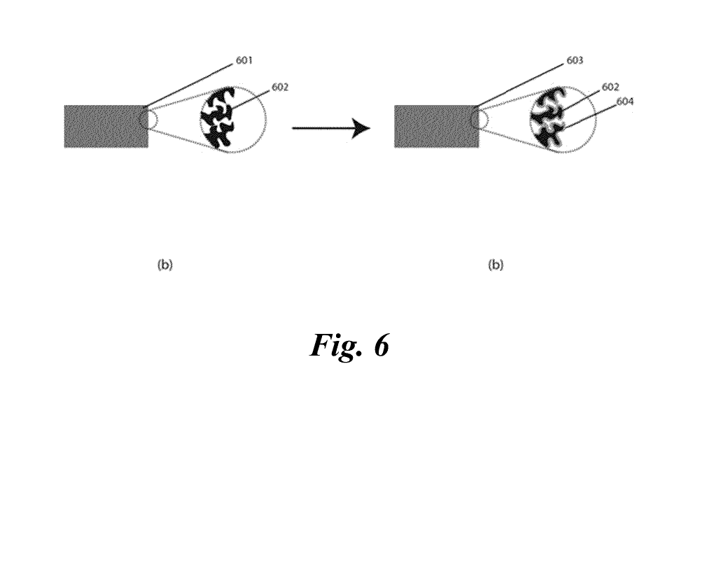

Referring now to FIG. 6, a nanostructured refractory material 601 comprised solely of an intermediate nanostructured refractory material 602 undergoes a surface modification to form a new nanostructured refractory material 603 comprising the intermediate nanostructured refractory material 602 with a modified surface 604. The depth of the surface phase 604 can range from 0.1 nm to 10,000 nm.

The technique of oxidizing, carburizing, or nitriding the intermediate nanostructured refractory is not limited to the formation of materials for high-strength applications. Replacing the non-refractory phase with other materials, such as oxides, can be used to fabricate tantalum capacitors.

As outlined by an AVX research group publication, several challenges exist in forming Ta—Ta₂O₅—MnO₂ composite structures with small, sub-100 nm, characteristic length scales. Typically in the fabrication of tantalum capacitors, Ta nanoparticles on the order of about 10 nm in diameter are sintered together at high temperature (greater than 1500° C.) to form a porous aggregate. During this process, the aggregate can lose up to 50% of its surface area due to coarsening, a high density of grain boundaries is retained, and the aggregate is easily contaminated during the sintering process. Horacek, et al., 2009; Upadhyaya, 2005.

A goal in the tantalum capacitor industry is to increase the capacitance per gram by increasing the surface area of the Ta₂O₅ oxide coating on the refractory phase. The following equation is used to estimate the capacitance of a parallel plate capacitor:

C=εε₀A/d

where ε is the dielectric constant of tantalum pentoxide (ε=26), ε₀ is the permittivity of free space (8.855×10⁻¹² F/m), A is the surface area in m², and d is the dielectric thickness in m. Barr, et al., 2006. The dielectric thickness depends on the voltage at which the capacitor is rated and is formed by anodizing the Ta nanostructure in a hot acid under an applied potential. Barr, et al., 2006. Typical high-performance Ta capacitors have a dielectric thickness on the order of 10 nm. Using this value for d and a surface area of 12 m²/g (a reasonable estimate based on the surface area of nanoporous gold), the capacitance of a Ta₂O₅—MnO₂ refractory nanocomposite is estimated to have a value of approximately 276 kCV/g. Snyder, 2010. Currently, the industry standard for a tantalum capacitor rated at 4V is 200 kCV/g, so the presently disclosed nanocomposite refractory material might out-perform the current state-of-the-art.

In one example, as provided in more detail herein below in Example 4, Ti is dissolved out of a Ti—Ta alloy and replaced with Cu, forming a Ta—Cu nanocomposite refractory. The Cu is then dissolved away, leaving behind a Ta intermediate nanostructured refractory material that is oxidized in a hot acidic electrolyte under an applied potential to form a layer of tantalum pentoxide (Ta₂O₅) on its surface. Gill, 1996. The tantalum oxide structure is then filled with a manganese salt, e.g. manganese nitrate, which is decomposed at an elevated temperature to form manganese oxide. Chen, 1996. This nanocomposite refractory material can be used as a capacitor. Barr, et al., 2006.

The advantages of making nanocomposite refractory tantalum capacitors include, but are not limited to: (i) easier processing of tantalum into a uncontaminated bicontinuous network microstructure with a small characteristic length scale by avoiding sintering; (ii) high interfacial area/volume ratios; (iii) mechanical and thermal stability due to the minimal fraction of grain boundaries; and (iv) high capacitance per gram.

In further embodiments the molten metal bath 101 does not need to be purely molten copper. Constituents may be added to the molten metal bath to lower the melting point of metal bath 101. Such constituents also need to have negative heat of mixtures with titanium and positive heat of mixtures with the refractory element, e.g., tantalum. Referring once again to FIG. 1, a molten metal bath 101 comprising copper-silver (Cu—Ag) is prepared in a crucible 102 with a composition, for example, of 72 at. % Ag-28 at. % Cu, which has a melting point of 779° C. The same procedure as described hereinabove is then followed: add the titanium-tantalum metal alloy 103; solidify the contents of the crucible, molten metal bath 101 and metal alloy 103; place both of the components in aqueous solution 301 in a container 302; and selectively dissolve the constituents of the molten metal bath 101/303.

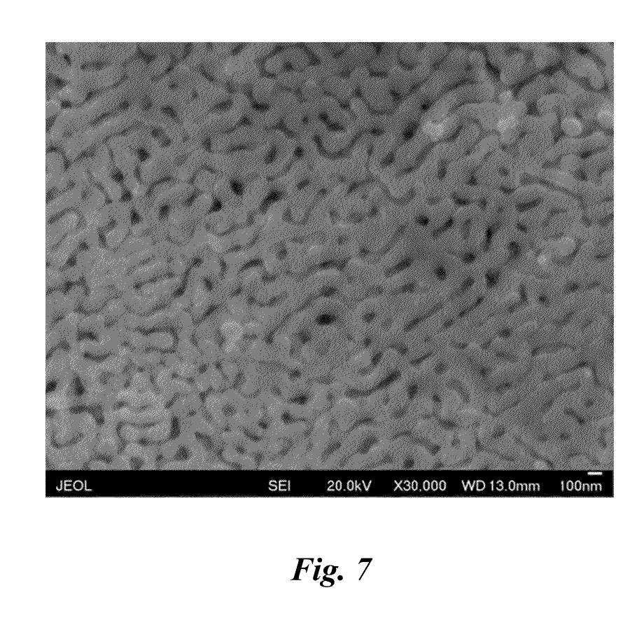

The lower melting point, and thus operating temperature for the process, alters the diffusion and dissolution kinetics of the process, namely slowing it and producing a microstructure having a smaller characteristic length scale. For example, compare the characteristic length scales of the materials shown in FIG. 4 and FIG. 7, which were prepared at 1084° C. and 779° C., respectively. The characteristic length scale, i.e., the diameter of the tantalum ligaments in FIG. 4, e.g., prepared at 1084° C., is approximately 2 micrometers and the characteristic length scale of the material in FIG. 7, e.g., prepared at 779° C., is approximately 100 nm, a factor of 20 smaller.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

### Example 1

### Tantalum-Copper Nanocomposite Refractory

In this embodiment, a tantalum-copper nanocomposite refractory is made, as shown in FIG. 2. First, following the procedure in FIG. 1, a nanocomposite refractory is made by immersing a Ta—Ti foil in molten Cu, and then solidifying the material and cooling to room temperature. Second, following the procedure disclosed in FIG. 3, an intermediate nanostructured refractory is made by immersing the material in a nitric acid solution to reveal the characteristic length scale.

More particularly, a 4-mm thick, 50-gram ingot of 80Ti—20Ta was rolled into a foil 150 micrometers thick and a 1-cm×1-cm foil was cut from this foil. The 1-cm×1-cm foil was annealed in a cast alumina crucible for 8 hours by radio-frequency induction heating under ultra-high vacuum (UHV), at a pressure of 1.1×10⁻⁸ Torr, and at a constant temperature of approximately 1500° C. The foil was then cooled and removed from the UHV environment. Separately, copper shot was melted in a graphite crucible using radio-frequency induction heating under flowing Ar gas and solidified to form a 5-gram ingot of copper.

The annealed Ti—Ta foil was then placed in a different cast alumina crucible, the 5-gram copper ingot was placed on top of the foil, and the crucible was heated slowly using radio-frequency induction heating under flowing 5% H_{2—}95% Ar gas until the copper melted. The melt was maintained at the same power to keep the temperature constant, and power was applied for five minutes. At this point, the power was turned off and the piece was allowed to cool to room temperature. The sample was mounted in Bakelite in a hotpress machine. The foil side was then polished using common methods known in the art. Once polished, the specimen was imaged using scanning electron microscopy. FIG. 2 is a micrograph of the material that was generated using this procedure.

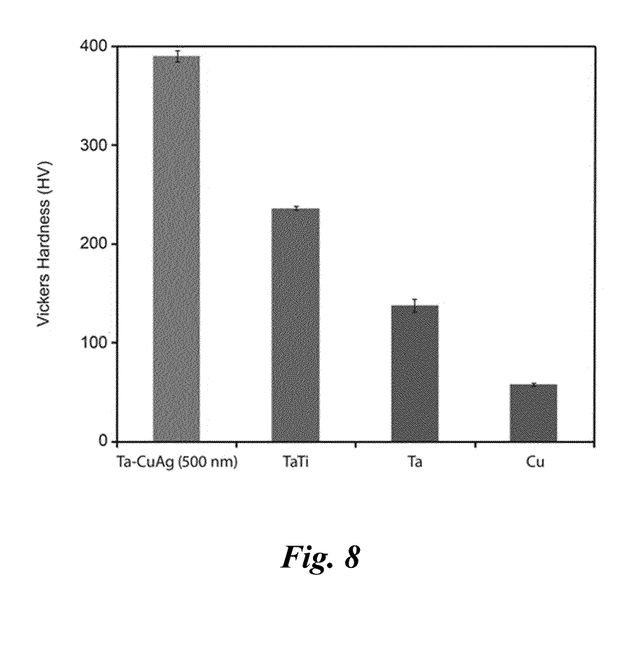

To evaluate the mechanical properties of the material made by this method, Vickers hardness tests were performed on the mounted and polished Ta—Cu composite, and compared with the starting Ti—Ta alloy, pure Cu, and pure Ta, all mounted in a Bakelite hotpress machine, and polished using common methods known in the art. Vickers tests were performed using a 500-gram load cell applied for 10 seconds. FIG. 8 is a comparison of the hardness values of all the materials.

The presently disclosed process leads to a nanocomposite refractory foil comprising bicontinuous phases, the first of which comprises tantalum and the second of which comprises copper. The starting alloy in this embodiment was 80Ti—20Ta, and yielded a structure with a characteristic length scale of approximately one micrometer. The characteristic length scale of the material can be altered slightly by adjusting the composition of the starting alloy. For example, increasing the Ta content and starting with a 60Ti—40Ta alloy and following the same procedure as above yielded a nanocomposite refractory with a characteristic length scale in the range from about 300 nm to about 500 nm.

### Example 2

### Intermediate Nanocomposite Refractory Comprising Tantalum

In this embodiment, an intermediate nanostructured refractory material substantially comprising tantalum is formed, as shown in FIG. 7. First, following the procedure in FIG. 1, a nanocomposite refractory is made by immersing a Ta—Ti foil in molten CuAg and then solidifying and cooling the material to room temperature. He, 2006. Second, following the procedure in FIG. 3, an intermediate nanostructured refractory is made by immersing the material in a nitric acid solution.

More particularly, a 4-mm thick 50-gram ingot of 60Ti—40Ta was rolled to 150 micrometers, and a 1-cm×1-cm foil was cut out. The 1-cm×1-cm foil was annealed in a cast alumina crucible for 8 hours by radio-frequency induction heating under a UHV environment, at a pressure of 1.08×10⁻⁸ Torr, and at a constant temperature of approximately 1500° C. The foil was then cooled and removed from the UHV environment. Separately, a 72Ag—28Cu alloy was made by melting copper shot and silver pellets in a graphite crucible using radio-frequency induction heating under flowing Ar gas and solidified to form a 5-gram ingot of 72Ag—28Cu.

The annealed Ti—Ta foil was then placed in a different cast alumina crucible, the 5-gram 78Ag—28Cu piece was placed on top, and the crucible was heated slowly using radio-frequency induction heating under flowing 5% H₂—95% Ar gas until the 78Ag—28Cu piece began to melt. The melt was maintained at the same power to keep the temperature constant, and power was applied for one hour. At this point the power was turned off and the piece was allowed to cool to room temperature. Excess solidified AgCu was removed, and the foil (now converted to a nanocomposite refractory), coated with the remaining AgCu alloy, was placed in a 50-mL solution of 1M nitric acid, as illustrated by FIG. 3, and was left until no more gas evolution caused by the dissolution of copper and silver was observed. The remaining foil was rinsed thoroughly in water and dried. FIG. 7 shows an SEM micrograph of the material generated by this procedure.

The presently disclosed process leads to an intermediate nanostructured refractory material comprising tantalum with a characteristic length scale on the order of about 100 nm.

### Example 3

### Intermediate Nanocomposite Refractory Comprising Tantalum

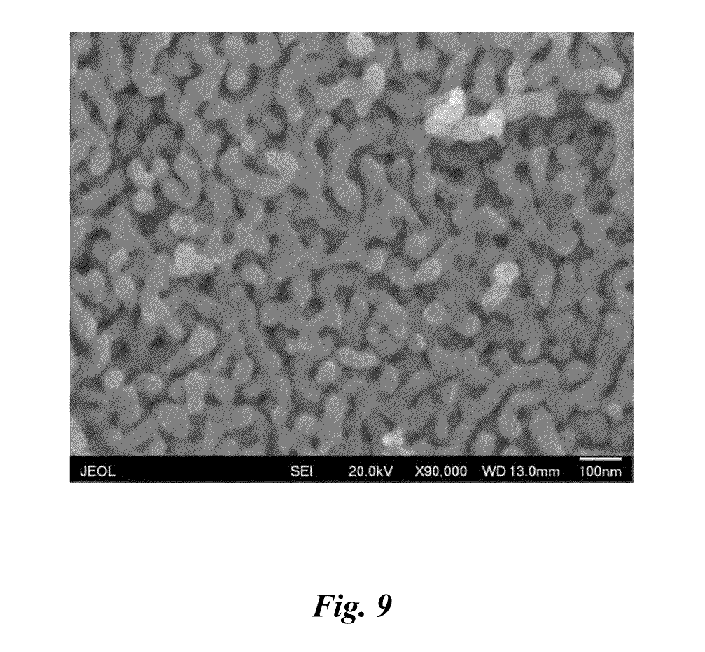

In this embodiment, an intermediate nanostructured refractory material is made, as shown in FIG. 9. First, following the procedure in FIG. 1, a composite structure is made by immersing a Ta—Ti foil in molten CuAgBi and then solidified and cooled to room temperature. Second, following the procedure in FIG. 3, an intermediate nanostructured refractory is made by immersing the material in a nitric acid solution.

More particularly, a 4-mm thick 50-gram ingot of 60Ti—40Ta was rolled to 150 micrometers, and a 1-cm×1-cm foil was cut out. The 1-cm×1-cm foil was annealed in a cast alumina crucible for 8 hours by radio-frequency induction heating under a UHV environment, at a pressure of 1.08×10⁻⁸ Torr, and at a constant temperature of approximately 1500° C. The foil was then cooled and removed from the UHV environment. Separately, a 60Ag—20Cu—20Bi alloy was made by melting copper shot, silver pellets, and bismuth pieces in a graphite crucible using radio-frequency induction heating under flowing Ar gas and solidified to form a 5-gram ingot of 60Ag—20Cu—20Bi.

The annealed Ti—Ta foil was then placed in a different cast alumina crucible, the 5-gram 60Ag—20Cu—20Bi piece was placed on top, and the crucible was heated slowly using radio-frequency induction heating under flowing 5% H₂—95% Ar gas until the 60Ag—20Cu—20Bi piece began to melt. The melt was maintained at the same power to keep the temperature constant, and power was applied for one hour. At this point the power was turned off and the piece was allowed to cool to room temperature. Excess solidified AgCuBi was removed, and the foil, coated with the remaining AgCuBi alloy, was placed in a 50-mL solution of 1M nitric acid, illustrated by FIG. 3, and was left until there was no more gas evolution caused by the dissolution of bismuth, copper and silver. The remaining foil was rinsed thoroughly in water and dried. FIG. 9 shows an SEM micrograph of the material generated by this procedure.

The presently disclosed process leads to an intermediate nanostructured refractory material with a characteristic length scale of approximately 30 nm. The composition picked for the ternary alloy into which titanium is dissolved, 60Ag—20Cu—20Bi, is not optimized for picking a composition with the lowest melting temperature. The melting point of the previously mentioned alloy is approximately 600° C., but this system can have a melting point of 400° C. at a composition of 38Ag—6Cu—56Bi. Liu, 2006. Following this trend, a nanocomposite refractory and intermediate nanostructured refractory material is expected to be produced with a characteristic length scale of approximately 10 nm.

### Example 4

### Ta—Ta₂O₅-MnO Nanocomposite Refractory

In this embodiment, a Ta—Ta₂O₅-MnO nanocomposite refractory is formed. First, following the procedure in FIG. 1, a nanocomposite refractory is made by immersing a Ta—Ti foil in molten CuAgBi, followed by solidifying and cooling to room temperature. Second, following the procedure in FIG. 3, an intermediate nanostructured refractory is made by immersing the material in a nitric acid solution. Third, the intermediate nanostructured refractory is electrochemically anodized to form a Ta₂O₅ surface upon the Ta and a Ta—Ta₂O₅—MnO nanocomposite is formed by filling the intermediate nanostructured refractory with manganese nitrate, which is then thermally decomposed to form manganese oxide.

More particularly, a 4-mm thick 50-gram ingot of 60Ti—40Ta was rolled to 150 micrometers, and a 1-cm×1-cm foil was cut out. The 1-cm×1-cm foil was annealed in a cast alumina crucible for 8 hours by radio-frequency induction heating under a UHV environment, at a pressure of 1.08×10⁻⁸Torr, and at a constant temperature of approximately 1500° C. The foil was then cooled and removed from the UHV environment. Separately, a 60Ag—20Cu—20Bi alloy was made by melting copper shot, silver pellets, and bismuth pieces in a graphite crucible using radio-frequency induction heating under flowing Ar gas and solidified to form a 5-gram ingot of 60Ag—20Cu—20Bi.

The annealed Ti—Ta foil was then placed in a different cast alumina crucible, the 5-gram 60Ag—20Cu—20Bi piece was placed on top, and the crucible was heated slowly using radio-frequency induction heating under flowing 5% H₂—95% Ar gas until the 60Ag—20Cu—20Bi piece began to melt. The melt was maintained at the same power to keep the temperature constant, and power was applied for one hour. At this point the power was turned off and the piece was allowed to cool to room temperature. Excess solidified AgCuBi was removed, and the foil, coated with the remaining AgCuBi alloy, was placed in a 50-mL solution of 1M nitric acid, illustrated in FIG. 3, and was left until there was no more gas evolution caused by the dissolution of bismuth, copper and silver. This procedure formed an initial intermediate nanostructured refractory comprising tantalum.

The surface of the intermediate nanostructured refractory comprising tantalum was then oxidized as follows: following typical tantalum processing, the foil was placed in a 1M sulfuric solution at 80° C., and a potential of 12 V was applied until the current sufficiently decayed. Barr, et al., 2006; Upadhyaya, 2005. This procedure created a second intermediate nanostructured refractory comprising tantalum coated with a tantalum pentoxide surface.

A final nanocomposite refractory was formed as follows: the intermediate nanostructured refractory comprising tantalum coated with tantalum pentoxide went through several iterations of dipping into dilute MnNO₃ solutions and heating to 250° C. in air to decompose the MnNO₃ into MnO₂ to form a Ta—Ta₂O₅—MnO₂ nanocomposite refractory, Barr, et al., 2006; Upadhyaya, 2005, suitable for use in a capacitor. Barr, et al., 2006; Upadhyaya, 2005.

### Example 5

### Tungsten-Copper Nanocomposite Refractory

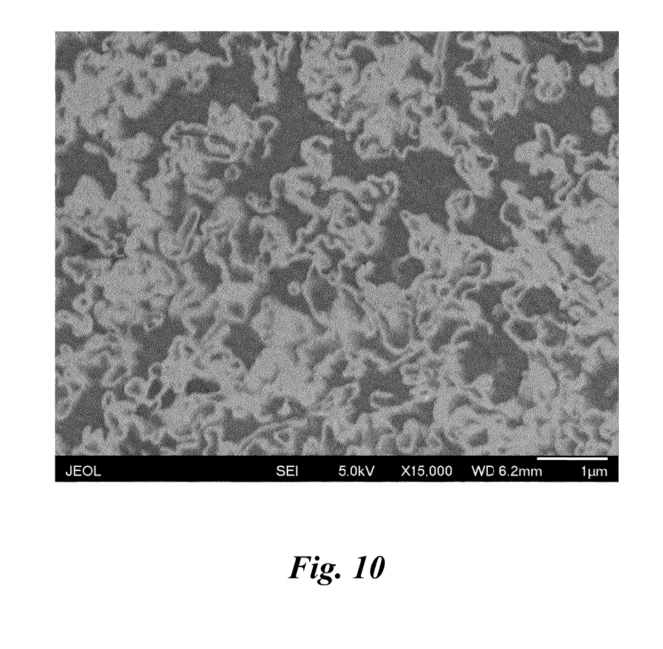

In this embodiment, a tungsten-copper nanocomposite refractory is made, as shown in FIG. 10. First, following the procedure in FIG. 1, a nanocomposite refractory is made by immersing a 1-cm³ sample of W—Ti foil in molten Cu, and then solidifying the material and cooling to room temperature. Second, following the procedure disclosed in FIG. 3, an intermediate nanostructured refractory is made by immersing the material in a nitric acid solution to reveal the characteristic length scale.

More particularly, a 1-cm³ sample was cut from a 4-mm thick, 50-gram ingot of 75Ti—25W. The 1-cm×1-cm×1-cm sample was annealed in a cast alumina crucible for 16 hours by radio-frequency induction heating under ultra-high vacuum (UHV), at a pressure of 1.1×10⁻⁸ Torr, and at a constant temperature of approximately 1500° C. The sample was then cooled and removed from the UHV environment. Separately, copper shot was melted in a graphite crucible using radio-frequency induction heating under flowing Ar gas and solidified to form a 15-gram ingot of copper.

The annealed 1-cm×1-cm×1-cm sample was then placed in a different cast alumina crucible, the 15-gram copper ingot was placed on top of the sample, and the crucible was heated slowly using radio-frequency induction heating under flowing 5% H₂—95% Ar gas until the copper melted. The melt was maintained at the same power to keep the temperature constant, and power was applied for five minutes. At this point, the power was turned off and the piece was allowed to cool to room temperature. The piece was mounted in Bakelite in a hotpress machine. The sample side was then polished using common methods known in the art. Once polished, the specimen was imaged using scanning electron microscopy. FIG. 10 is a micrograph of the material that was generated using this procedure.

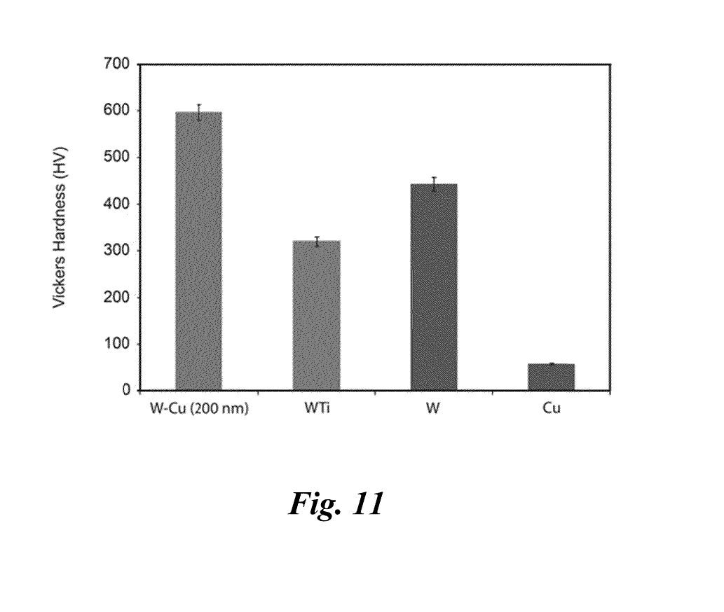

To evaluate the mechanical properties of the material made by this method, Vickers hardness tests were performed on the mounted and polished W—Cu composite, and compared with the starting W—Ti alloy, pure Cu, and pure W, all mounted in a Bakelite hotpress machine, and polished using common methods known in the art. Vickers tests were performed using a 500 gram load cell applied for 10 seconds. FIG. 11 is a comparison of the hardness values of all the materials. Note that the composite has a higher strength than either component combined.

The presently disclosed process leads to a nanocomposite refractory foil comprising bicontinuous phases, the first of which comprises tungsten and the second of which comprises copper. The starting alloy in this embodiment was 75Ti—25W, and yielded a structure with a characteristic length scale in the range of 100 nm to about 500 nm. The characteristic length scale of the material can be altered slightly by adjusting the composition of the starting alloy. For example, increasing the W content and starting with a 60Ti—40W alloy and following the same procedure as above would yielded a nanocomposite refractory having a characteristic length scale in the range from about 50 nm to about 200 nm.

### Example 6

### Tungsten Nitride-Copper Nanocomposite Refractory

In this embodiment, a tungsten nitride-copper nanocomposite refractory can be made. First, following the procedure in FIG. 1, a nanocomposite refractory is made by immersing a 1-cm³ sample of W—Ti foil in molten Cu, and then solidifying the material and cooling to room temperature. Second, following the procedure disclosed in FIG. 3, an intermediate nanostructured refractory is made by immersing the material in a nitric acid solution. Third, the intermediate nanostructured refractory can be nitrided to form a tungsten nitride surface, and a W-Tungsten Nitride (WN)—Cu composite can be formed by filling the intermediate nanostructured refractory with molten Cu, which is then solidified and cooled to room temperature.

More particularly, the following procedure can be used to prepare a tungsten nitride-copper nanocomposite refractory. First, a 1-cm³ sample is cut from a 4-mm thick, 50-gram ingot of 75Ti—25W. The 1-cm×1-cm×1-cm sample is annealed in a cast alumina crucible for 16 hours by radio-frequency induction heating under ultra-high vacuum (UHV), at a pressure of 1.1×10⁻⁸ Torr, and at a constant temperature of approximately 1500° C. The sample is then cooled and removed from the UHV environment. Separately, copper shot is melted in a graphite crucible using radio-frequency induction heating under flowing Ar gas and is solidified to form a 15-gram ingot of copper.

The annealed 1-cmx 1-cm×1-cm sample is then placed in a different cast alumina crucible, the 15-gram copper ingot is placed on top of the sample, and the crucible is heated slowly using radio-frequency induction heating under flowing 5% H₂—95% Ar gas until the copper is melted. The melt is maintained at the same power to keep the temperature constant, and power is applied for five minutes. At this point, the power is turned off and the piece is allowed to cool to room temperature. Excess solidified Cu is removed, and the sample, coated with the remaining Cu, is placed in a 50-mL solution of 1M nitric acid, illustrated in FIG. 3, and is left until there is no more gas evolution caused by the dissolution of copper. This procedure forms an initial intermediate nanostructured refractory comprising tungsten.

The surface of the intermediate nanostructured refractory comprising tungsten then can be nitrided as follows: following typical gas nitriding processing, the sample is placed under flowing ammonia gas, and is heated between 495° C. and 600° C., Parrish, 1999. This procedure creates a second intermediate nanostructured refractory comprising tungsten coated with a tungsten nitride surface.

A final nanocomposite refractory can be formed as follows: the intermediate nanostructured refractory comprising tungsten coated with tungsten nitride is immersed in molten Cu at or above the melting point of Cu, 1084° C., under flowing 5% H₂—95% Ar gas, and then the Cu is solidified by cooling to room temperature to form a W—WN—Cu nanocomposite refractory.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

William Callister. Materials Science and Engineering: An Introduction, 8th Edition. Hoboken, N.J.: John Wiley & Sons, Inc., 2006.

J. Roesler, H. Harders, M. Baeker. Mechanical Behaviour of Engineering Materials. New York City, N.Y.: Springer, 2006.

T. M. Pollock, S. Tin, J. Propul. Power, 22, 2 (2006), 361-374.

R. F. Decker, Presented at Steel Strengthening Mechanisms Symposium; Zurich, Switzerland, (1969).

R. W. Ballufi, S. M. Allen, W. C. Cater, Kinetics of Materials: New York City, N.Y.: Wiley-Interscience, 2005.

M. W. Chen, E. Ma, K. J. Hemker, Mechanical behavior of nanocrystalline metals, in CRC Handbook of Nanomaterials, CRC Publisher, 2005.

K. Wang, J. Weissmuller, Adv. Mater., 25, 9 (2013), 1280-1284.

J. Erlebacher, J. Electrochem. Soc. 151, C614 (2004).

J. Snyder, K. Livi, and J. Erlebacher, J. Electrochem. Soc. 155, C464 (2008).

R. Li, K. Sieradzki, Phys. Rev. Lett., 68, 8 (1992), 1168-1171.

H. J. Jin, L. Kurmanaeva, J. Schmauch, H. Rösner, Y. Ivanisenko, J. Weissmüller, Acta. Mater., 57, 9 (2009) 2665-2672.

T. Wada, H. Kato, Scripta Mater. 68, 9 (2013), 723-726.

H. Kato, T. Wada, K. Yubuta, A. Inouie, US Patent 2012/0295129, filed Oct. 22, 2010; published Nov. 22, 2012.

Kaufman L., Ti—Ta Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Jonsson S., Ti—W Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Rudy E., Ti—Mo Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Okamoto H., Ti—Nb Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Murray J. L., Ti—Re Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Kaufman L., Cu—Ta Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Okamoto H., Ti—Nb Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Turchanin M. A, Ti—Cu Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Li M., Ti—Ag Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Vassilev G. P., Ti—Bi Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

D. Mordehai, S. W Lee, B. Backes, D. J. Srolovitz, W. D. Nic, E. Rabkin, Acta. Mater. 59 (2011) 5202-5215.

T. M. Pollock, S. Tin, J. Propul. Power. 22, 2 (2006) 361-374.

Y. Ding, Y.-J Kim, J. Erlebacher, Adv. Mater., 16, 21 (2004), 1897-1900.

J. G. Chen, Chem. Rev. 96 (1996), 1477-1498.

J. Gill, AVX Technical Information Articles, 1996.

J. L. Barr, R. L. Axelbaum, M. E. Macias, J. Nanoparticle Research, 8 (2006), 11.

I. Horacek, T. Zednicek, S. Zednicek, T. Karnik, J. Petrzilek, P. Jacisko, P. Gregorova, I. Pinwill, “High CV Tantalum Capacitors—Challenges and Limitations,” AVX Technical Information, 2009.

G. S. Upadhyaya, Bull. Mater. Sci., 28 (2005), 305-307.

J. Snyder, T. Fujita, M. W. Chen, J. Erlebacher, Nature Mater. 9, 904 (2010).

X. C He, Cu—Ag Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

S. Liu, Ag—Cu—Bi Phase Diagram, ASM Alloy Phase Diagrams Center, P. Villars, editor-in-chief; H. Okamoto and K. Cenzual, section editors; http://wwwl.asminternational.org/AsmEnterprise/APD, ASM International, Materials Park, Ohio, 2006.

Geoffrey Parrish. Carburizing: Microstructures and Properties. ASM International, Materials Park, Ohio, 1999.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A nanocomposite refractory material comprising:
a bicontinuous non-porous microstructure comprising a refractory phase and a non-refractory phase, wherein the refractory phase substantially comprises one or more refractory elements and the non-refractory phase comprises a void filled by one or more materials, wherein the one or more materials filling the void are different than a material comprising the non-refractory phase in a bicontinuous network from which the nanocomposite refractory material is formed.

2. The nanocomposite refractory material of claim 1, wherein the one or more refractory elements is selected from the group consisting of tantalum (Ta), tungsten (W), molybdenum (Mo), niobium (Nb), rhenium (Re).

3. The nanocomposite refractory material of claim 1, wherein a surface, bulk, or combination thereof of the refractory phase comprises an oxide, nitride, or carbide of the one or more refractory elements.

4. The nanocomposite refractory material of claim 1, wherein the one or more materials filling the void in the non-refractory phase is selected from the group consisting of a polymer, an oxide, a ceramic, an alloy, and a metal different from a metal comprising the non-refractory phase in a bicontinuous network from which the nanocomposite refractory material is formed.

5. The nanocomposite refractory material of claim 1, wherein the nanocomposite refractory material has a characteristic length scale of greater than about 10 nm and less than about 10,000 nm.

6. The nanocomposite refractory material of claim 5, wherein the characteristic length scale has a range of about 300 nm to about 500 nm.

7. A method for preparing a nanocomposite refractory material comprising a bicontinuous solid microstructure comprising a refractory phase and a non-refractory phase, wherein the refractory phase substantially comprises one or more refractory elements, and the non-refractory phase comprises a void filled by one or more materials, wherein the one or more materials filling the void are different than a material comprising the non-refractory phase in a bicontinuous network from which the nanocomposite refractory material is formed, the method comprising:
(a) immersing a precursor alloy comprising one or more refractory elements and a first metal in a molten metal bath comprising one or more second metals to form a bicontinuous network comprising a refractory phase comprising one or more refractory elements and a non-refractory phase comprising the one or more second metals;
(b) cooling the bicontinuous network to form a solidified material comprising the refractory phase and the non-refractory phase;
(c) immersing the solidified material in an acid or alkali aqueous solution, wherein the one or more second metals comprising the non-refractory phase are dissolved in the acid or alkali aqueous solution, thereby forming an intermediate nanostructured refractory material having a void in the non-refractory phase; and
(d) filling the void in the non-refractory phase of the intermediate nanostructure refractory material with a material different from the one or more second metals comprising the molten metal bath to form a nanostructure refractory material.

8. The method of claim 7, wherein the one or more refractory elements is selected from the group consisting of tantalum (Ta), tungsten (W), molybdenum (Mo), niobium (Nb), rhenium (Re).

9. The method of claim 7, wherein the molten metal bath comprises one or more second metals selected from the group consisting of copper, silver, bismuth, and combinations thereof.

10. The method of claim 7, wherein the intermediate nanostructure refractory has a characteristic length scale.

11. The method of claim 7, wherein the one or more different materials is selected from the group consisting of a polymer, an oxide, a ceramic, an alloy, or a metal that was not a constituent of the liquid metal bath.

12. The method of claim 7, further comprising chemically transforming a surface, bulk, and combination thereof of the refractory phase into an oxide, a nitride, or a carbide of the refractory element thereof.

13. The method of claim 12, wherein the surface, bulk, and combination thereof of the refractory phase is chemically transformed into an oxide, a nitride, or a carbide of the refractory element thereof prior to filling the void in the non-refractory phase of the intermediate nanostructure refractory material with a material different from the one or more second metals comprising the molten metal bath to form a nanostructure refractory material.

14. The method of claim 7, wherein the nanocomposite refractory material is a tantalum-copper nanocomposite refractory.

15. The method of claim 7, wherein the one or more refractory elements and a first metal comprising the precursor alloy have a negative heat of mixing.

16. The method of claim 7, wherein the one or more refractory elements comprising the precursor alloy and the one or more second metals comprising the molten metal bath have a positive heat of mixing.

17. The method of claim 7, wherein the first metal comprising the precursor alloy and the one or more second metals comprising the molten metal bath have a negative heat of mixing.

18. The method of claim 7, wherein the precursor alloy has a higher melting point than that of the one or more second metals comprising the molten metal bath.

19. A nanocomposite refractory material prepared by the method of claim 7.

20. The nanocomposite refractory material of claim 19, comprising Ta—Ta₂O₅—MnO.

21. The nanocomposite refractory material of claim 19, comprising a capacitor.
